(19) United States
(12) Patent Application Publication
(10) Pub. No.: US 2013/0142371 A1
(43) Pub. Date: Jun. 6, 2013

(54) Detachable Audio Speakers for Portable Devices and Methods for Manufacturing such Speakers

(71) Applicants: Jason P. MARTIN, Lake Oswego, OR (US); Patrick R. Triato, Portland, OR (US); Mark A. Schneider, Ridgefield, WA (US)

(72) Inventors: Jason P. MARTIN, Lake Oswego, OR (US); Patrick R. Triato, Portland, OR (US); Mark A. Schneider, Ridgefield, WA (US)

(21) Appl. No.: 13/309,436

(22) Filed: Dec. 1, 2011

(51) Int. Cl. H04R 1/02; B23P 11/00

(52) U.S. Cl. 381/333; 381/334; 29/428

(57) ABSTRACT

A portable audio speaker system is configured as a generally tubular structure with a slot along its side, into which the edge of a laptop screen or tablet computer may be inserted. Audio drivers within the structure reproduce sounds from the computer. Embodiments may be wired or wireless. Other features and manufacturing techniques are described and claimed.

### CONTINUITY AND CLAIM OF PRIORITY

This is an original U.S. patent application.

### FIELD

The invention relates to binaural and stereophonic speaker systems. More specifically, the invention relates to portable, removable accessory speaker systems for use with portable computers such as laptops and tablets.

### BACKGROUND

Portable entertainment and computing devices have benefitted greatly from the development of microelectronics, display technologies, high-density power storage batteries and strong, lightweight materials. However, one aspect of an immersive multimedia experience has tended to suffer as devices become smaller and thinner: audio performance. Sound volume and reproduction quality depend on the ability to physically move substantial volumes of air, which is difficult to accomplish with a small, thin, low-power transducer or speaker. Consequently, auxiliary audio systems (external speakers, subwoofers and the like) are popular additions to entertainment systems.

The current popularity of small, thin computing devices such as cell phones and tablet computers (as well as traditional “clamshell”-style laptop computers) for playing multimedia content has engendered new interest in ways to improve audio performance when these devices are used for free-air sound reproduction (as opposed to headphones). A sturdy, stylish auxiliary speaker system that integrates well with contemporary devices may be well-received by consumers.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a typical embodiment of the invention, including an example of the embodiment in use.

FIG. 2 shows a side view of an embodiment.

FIG. 3 shows several side views to illustrate various slot lining profiles.

FIG. 4 is an exploded diagram of an embodiment comprising separate outer body and slot lining subassemblies.

FIG. 5 is an exploded diagram showing audio reproduction and power components that may be found in an embodiment.

FIG. 6 shows how an embodiment may have an accessory-storage cavity formed in it.

FIG. 7 is a detail view showing a slot grip-enhancing structure.

FIG. 8 shows another approach for securing an embodiment to a computer or display panel.

FIG. 9 shows an embodiment installed on the screen of a laptop computer.

FIG. 10 shows a “kickstand” structure that can be used to support a laptop in an upright position.

FIG. 11 shows an alternate support structure.

FIG. 12 shows another alternate support structure.

FIG. 13 shows an embodiment that provides access to an interior chamber containing, for example, batteries.

### DETAILED DESCRIPTION

Embodiments of the invention provide binaural/stereophonic sound reproduction in a portable form factor that is adapted to be attached to an edge of a thin, flat display panel such as a laptop screen or tablet computer. These auxiliary speakers can provide greater volume and improved sound quality compared to the audio drivers in the basic laptop or tablet. In addition, the form factor may make the device easier to grip or handle, or may permit it to stand upright without external support.

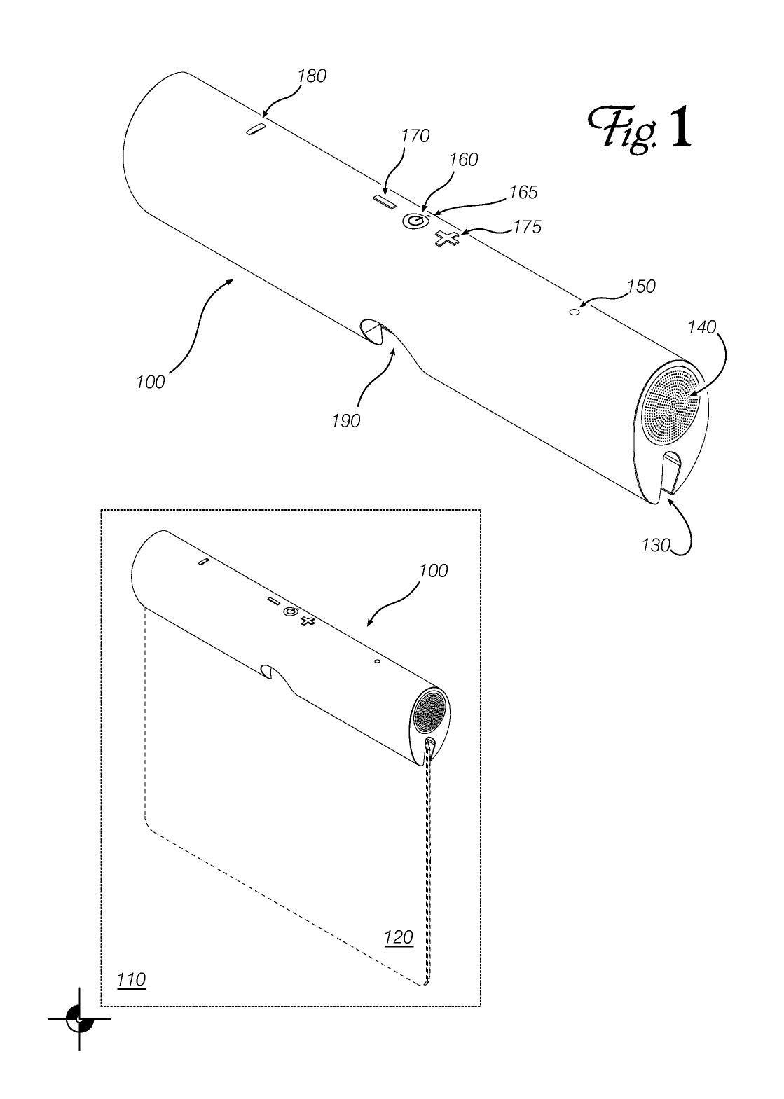

FIG. 1 shows a typical embodiment of the invention 100; inset 110 shows the embodiment attached to a tablet computer 120 by inserting the edge of the computer into a slot that is partially visible at 130 in the main view. Overall, this embodiment is in the shape of a tube or oval cylinder with the aforementioned slot 130 extending along one long side. The exact profile of an embodiment is not critical and can be adjusted to meet preferred stylistic goals or to provide improved secondary characteristics such as ease of grip or handling.

The audio transducers (drivers, speakers) in this embodiment are located at the ends of the tube, facing outward; one driver is behind perforated circular grille 140, while the other is not visible in this view. In other embodiments, the speakers may be oriented perpendicularly to the axis of the cylinder, for example facing towards a viewer in front of the screen, or out the rear (e.g., for a low-frequency driver or “woofer”). Some embodiments may include more than two speakers: for example, a pair of drivers to provide stereophonic reproduction of midrange and high frequencies, as well as one or more low-frequency woofers. It is appreciated that low frequencies contribute less to the creation of the impression of sound source separation, so it may not be as important to have multiple and/or physically-separated low-frequency transducers.

An embodiment may also contain an audio microphone, located here at 150. Other controls may be located on the surface of the embodiment, such as power button 160 and volume buttons 170 and 175. An indicator light or LED 165 may also be provided. Opening 180 provides access to a connection port such as a Universal Serial Bus (“USB”) connector, which may be used to charge batteries in the unit or to access internal storage or configuration functions. This embodiment includes a semi-circular cutout at 190 to expose a portion of the tablet's edge that would otherwise be obscured within slot 130. The exposed portion may be a control button near the edge of the tablet, a receiver for an infrared (“IR”) remote control, or a camera lens. Other embodiments may include a transparent window in the body to expose a camera lens.

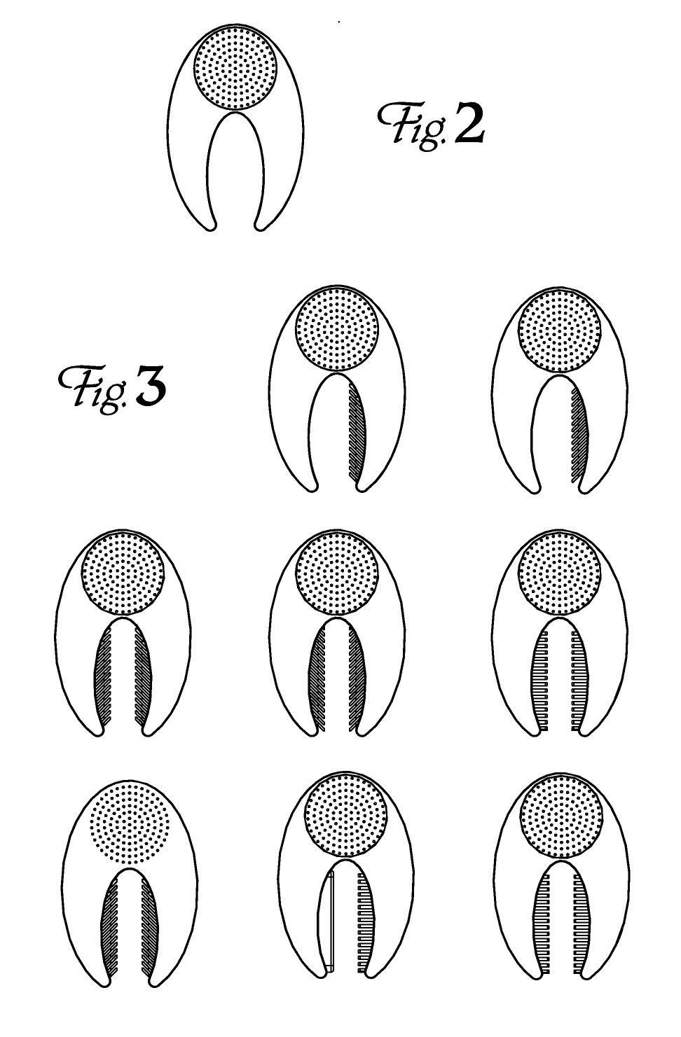

An embodiment may be designed to fit a particular model of tablet or laptop screen (note, for example, the asymmetrical profile of the slot at 130 in FIG. 1: this is especially well suited to accept the edge of an iPad® tablet computer manufactured by Apple Inc. of Cupertino, Calif.). Other embodiments may have a symmetrical slot profile (see, e.g., FIG. 2) to accept the edge of a flat (i.e., parallel-sided) tablet computer, cellular telephone or display screen. The slot may also be lined with ridges, fingers or similar structures (or with a smooth or textured material) that provides an improved grip to prevent the device from inadvertently slipping off from the screen. FIG. 3 shows a number of sample slot lining profiles, with fingers on one or both sides, directed into or out of the slot, perpendicular to a tablet or screen inserted into the slot, and so on. These slot linings may be made from a softer material than the main body. For example, if the main body is a relatively high-durometer silicone material, a softer, anti-slip silicone may be used for the slot lining.

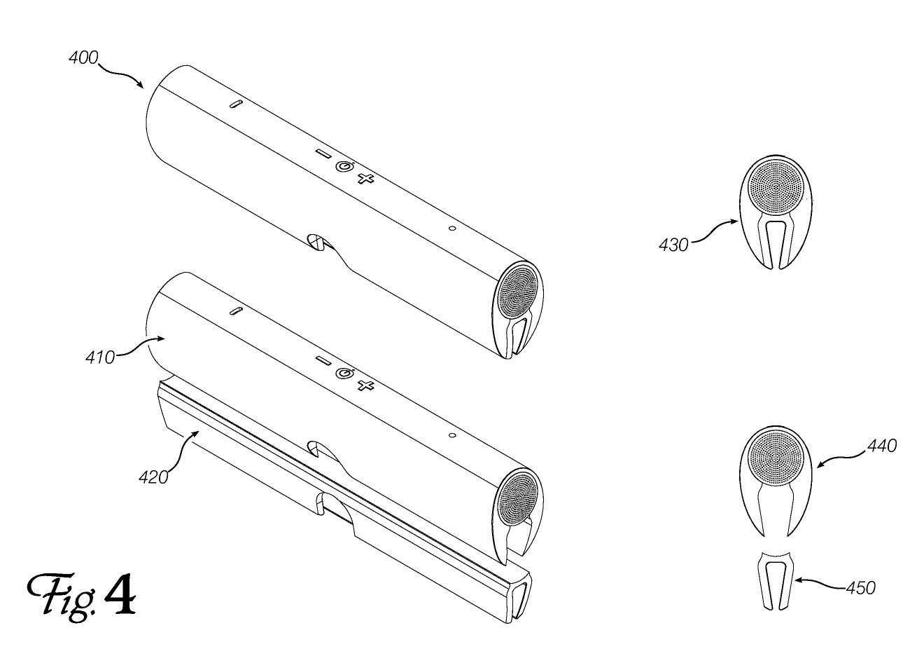

The fingers, ridges or other slot lining may be formed of the same material as the body of the housing, or may be formed as a separate subassembly that is inserted into the slot during manufacture. An example of this arrangement is shown in FIG. 4. There, embodiment 400 is shown in partially-exploded form, with a first or outer subassembly 410 and a second, inner or slot subassembly 420. Side views 430 and 440/450 show the inner and outer subassemblies. This embodiment may be advantageous from a manufacturing perspective, as discussed below.

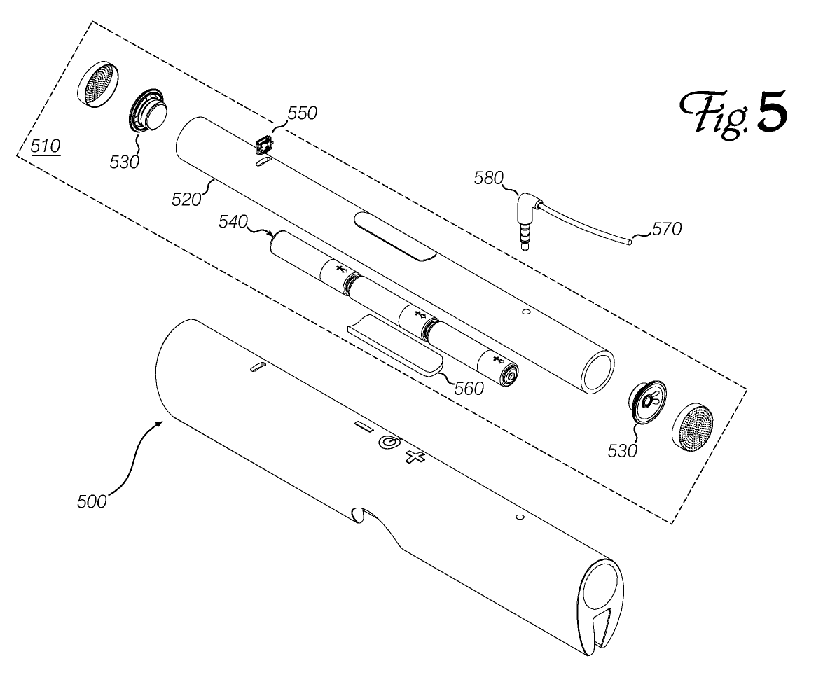

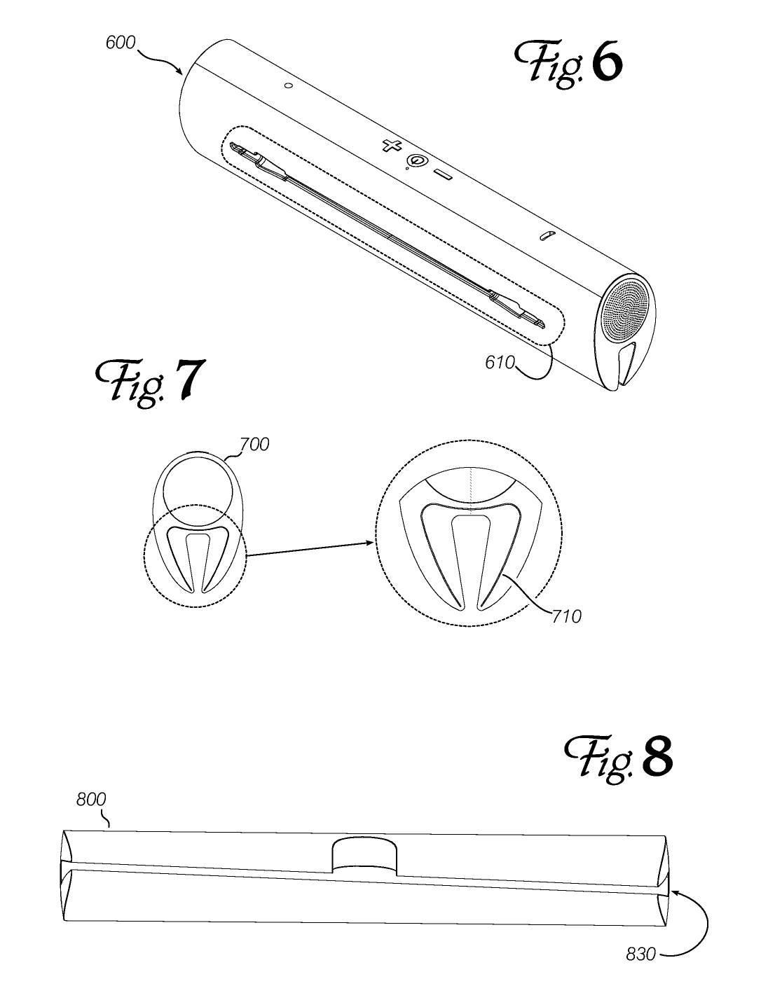

FIG. 5 shows an exploded view of another embodiment of the invention. Again, a generally oval profile main body 500 is provided, within which a sound-and-electronics module 510 is installed. Module 510 may have a tubular chassis 520 containing components such as speakers 530, batteries 540, and USB connector 550, as well as associated power control, audio reception, amplification and other circuitry (not shown). In this embodiment, batteries 540 may be changed by removing a hatch 560, accessible from inside the slot of the main body 500, or by removing module 510 from main body 500. An audio signal may be introduced to an embodiment by a standard multi-conductor cable 570 terminating in a plug 580, which mates with a jack (not shown) inside module 510. An embodiment may have a cavity formed in its main body to store an audio cable when not in use, as shown at 610 in FIG. 6. Similar cavities may provide storage for other accessories.

An embodiment may use an ordinary cable to receive the audio signal to be reproduced, as discussed above; but other embodiments may receive the signal wirelessly, using a radio-based technology such as Bluetooth® or a light-based (optical) technology such as a proprietary or open-standard-based infrared signal. Some embodiments may transmit, as well as receive, audio signals. For example, an auxiliary speaker system comprising a microphone may be useful for teleconferencing or videoconferencing, or a microphone may be used to monitor the environment where the system is being used and adjust the volume or spectral characteristics of the playback signal to suit. The audio signal from a microphone may be returned to the computing or entertainment device using a wired or wireless connection.

An embodiment may employ a variety of additional techniques to prevent it from slipping off the edge of a display screen, instead of (or in addition to the slot-lining fingers or ridges shown in FIG. 3). For example, in FIG. 7, a spring steel channel structure 710 is embedded in the material that forms the main body of the structure to provide extra strength to the grip of the slot on the device inserted therein. A two-piece embodiment such as shown in FIG. 4 may be easier to manufacture: instead of forming the main body with an embedded spring, the slot-lining piece may contain the spring steel channel. This arrangement also permits a common outer subassembly to be joined with different slot subassemblies that are adapted to grip a particular size or model of tablet or display, thus producing finished products that fit particular devices better.

In other embodiments, a manually-activated spring can be squeezed to release tension on the slot, and released once the tablet or laptop screen has been inserted, thus gripping the screen firmly. In an embodiment for use with Apple's iPad®, magnets can be embedded in the slot sides to attract complementary magnets located in the iPad case.

FIG. 8 shows a bottom view of another embodiment where the main body 800 is formed with a slight twist, so that the slot is helical rather than straight (as in many other embodiments). If the body is formed of a resilient material such as silicone, it can be untwisted to insert the edge of the tablet or laptop display, and when released, the return to the twisted resting state will hold the display securely.

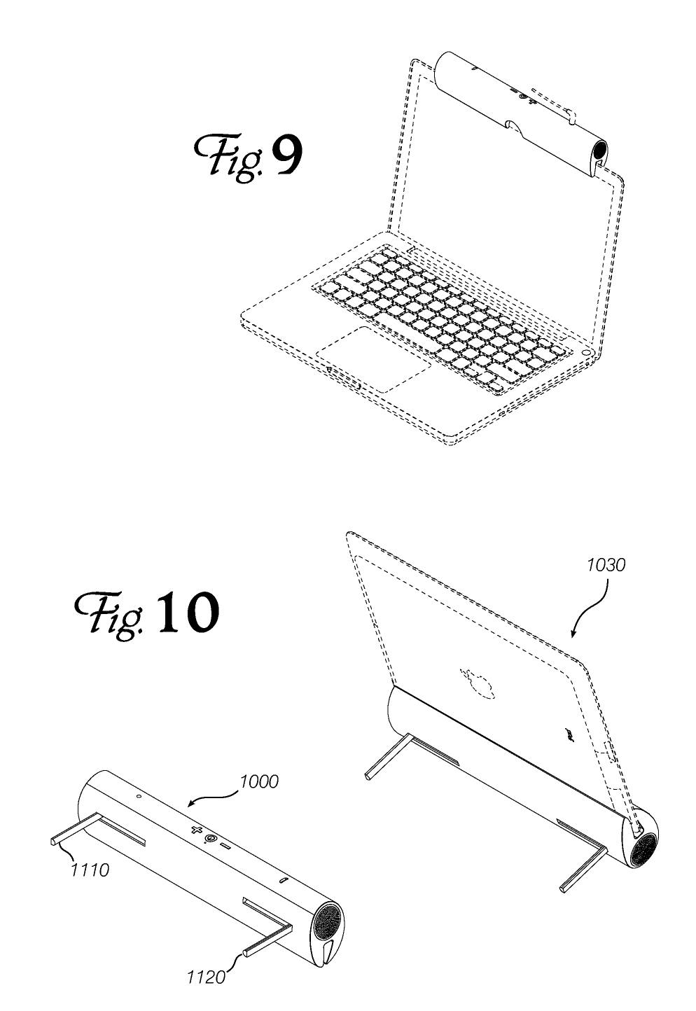

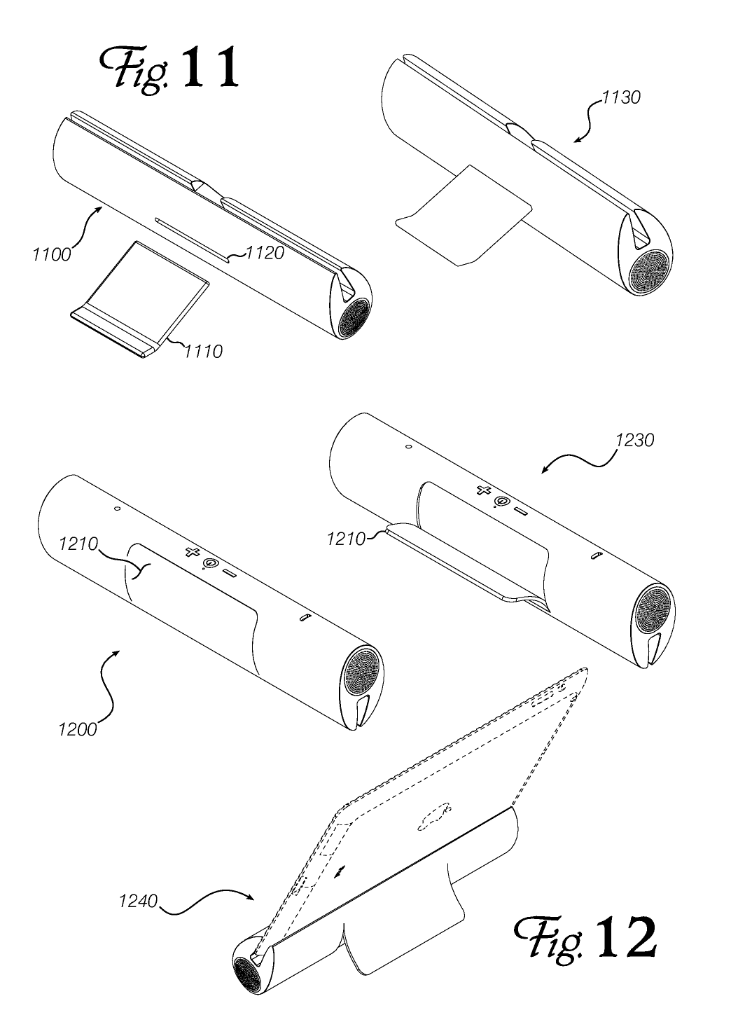

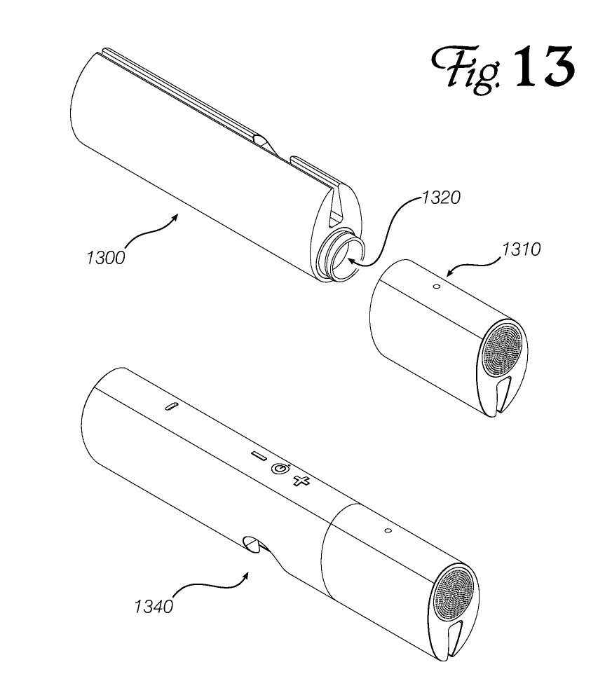

Some devices that may be used with an embodiment of the invention are self-stable (that is, they can be placed in a desired configuration and remain that way without further support). The laptop with an embodiment along its screen top, shown in FIG. 9, is an example. However, some embodiments may be provided with one or more collapsible or separable protrusions to serve as a “kick stand” to support a tablet device in a preferred viewing position. FIG. 10 shows one such embodiment at 1000: flip-out rods 1010 and 1020 permit the embodiment to support a tablet computer in an upright position, as shown at 1030. FIG. 11 shows a different approach to providing support: embodiment 1100 has a slot 1110 into which a separate panel 1120 may be inserted to give the structure shown at 1130. The illustrations of FIG. 12 show a third approach: embodiment 1200 has a panel 1210 formed in a portion of its main body. When the panel is peeled away as shown at 1230, the embodiment can support a tablet (see 1240).

As mentioned earlier, some embodiments may contain rechargeable batteries, which can be recharged by connecting the accessory to a USB port. Other embodiments may use single-use, disposable batteries. To provide access more easily than, for example, the concealed hatch 560 shown in FIG. 5, an embodiment may use a twist-off, “flashlight”-style cap as shown in FIG. 13. There, a portion 1310 of the main body 1300 can be twisted or snapped apart from the rest, giving access to a battery chamber 1320. When cap 1310 is replaced, this embodiment appears and functions similarly to the other embodiments discussed herein (see 1340).

An embodiment where the main body is formed of silicone, can be manufactured efficiently by making the channel to hold the sound-and-electronics module open (i.e., without enclosed voids). A second slot-lining subassembly (perhaps made of a lower-durometer silicone, as discussed in [0024]) can be formed separately, then inserted into the slot in the main body after the active components. The slot lining serves to secure the active components in the open channel in the main body and to close that channel, and also to contact the edge of a display when the device is in use.

It is appreciated that, although some embodiments will permit the attached computer (e.g. , tablet computer or cell phone) to stand upright, an embodiment may also be used as a handle to hold the computer in a suitable attitude for viewing. Thus, the outer profile of the embodiment may be shaped for easy grip, or formed from (or coated with) a grip-enhancing, anti-slip material. For example, silicone rubber (of suitable durometer) is easy to grasp and may provide some shock or impact absorption if the computer is dropped.

The structures and features of the present invention have been described largely by reference to specific example embodiments. However, those of skill in the art will recognize that auxiliary audio speaker accessories can also be constructed with different combinations of features than herein described. Such variations are understood to be captured according to the following claims.

We claim:

1. A portable audio speaker system comprising:
a substantially tubular housing having a slot along one side, said slot adapted to accept an edge of a display screen of a computing device;
a plurality of audio drivers disposed within the housing to reproduce sounds;
audio signal receiving means for receiving an audio signal from the computing device, said audio signal to be reproduced by the plurality of audio drivers.

2. The portable audio speaker system of claim 1, further comprising:
a spring clamp to assist in securing the housing to the edge of the display screen.

3. The portable audio speaker system of claim 1, further comprising:
an amplifier to amplify the audio signal; and
a battery to supply power for the amplifier.

4. The portable audio speaker system of claim 1, further comprising:
a substantially cylindrical sound tube disposed within the housing, said sound tube containing the plurality of audio drivers.

5. The portable audio speaker system of claim 1 wherein the housing is formed of a plurality of subassemblies joined together,
a first of said subassemblies forming a majority of a volume of the speaker system; and
a second of said subassemblies mostly lining the slot of the housing so that the second subassembly contacts the edge of the display screen.

6. The portable audio speaker system of claim 1, further comprising:
a cutout along a portion of the slot, said cutout positioned so as to provide access to a portion of the display screen that would otherwise be occluded by the housing.

7. The portable audio speaker system of claim 1 wherein the audio signal receiving means is a multi-conductor wire terminating in an audio plug, said audio plug to be connected to a corresponding audio output jack of the computing device.

8. The portable audio speaker system of claim 1 wherein the audio signal receiving means is a wireless radio receiver.

9. The portable audio speaker system of claim 1 wherein the audio signal receiving means is an optical signal receiver.

10. A method of constructing an accessory housing to contain a computing device accessory and to removably attach the accessory to an edge of a screen of the computing device, comprising:
forming a first housing component of a first material, said first housing component being substantially without enclosed voids, said first housing component having a longitudinal slot sized to accept an edge of a display of a computing device;
forming a second housing component of a second material, said second housing component adapted to fit in the longitudinal slot and to contact the edge of the display of the computing device;
inserting active components of the computing device accessory into an opening in the first housing component; and
inserting the second housing component into the longitudinal slot to secure the active components in the opening.

11. An external audio speaker accessory for a mobile computing device comprising:
a generally oval-profile cylindrical housing having a slot along its length on one side;
audio drivers located near a first end of the cylindrical housing and a second end of the cylindrical housing;
an audio amplifier to accept a signal from the mobile computing device, amplify it and reproduce it through the audio drivers; and
gripping means to attach the cylindrical housing to an edge of the mobile computing device inserted into the slot.

12. The external audio speaker accessory of claim 11 wherein the gripping means is at least one anti-slip material disposed within the slot.

13. The external audio speaker accessory of claim 11 wherein the gripping means is a spring insert to strengthen a grip of edges of the slot.

14. The external audio speaker accessory of claim 11 wherein the gripping means is a plurality of manually-activated springs to strengthen a grip of edges of the slot.

15. The external audio speaker accessory of claim 11 wherein the gripping means is a natural helical twist of the slot.

16. The external audio speaker accessory of claim 11 wherein the gripping means is a plurality of magnets positioned to attract complementary magnets in the edge of the mobile computing device.

17. The external audio speaker accessory of claim 11, further comprising:
a microphone, wherein audio from said microphone is to be provided to the mobile computing device.

18. The external audio speaker accessory of claim 11 wherein a cap portion of the housing is separable by twisting, and
wherein removal of the cap portion affords access to an internal battery compartment.

19. The external audio speaker accessory of claim 11, further comprising:
a collapsible protrusion to support the mobile computing device in an upright attitude.

20. The external audio speaker accessory of claim 11, further comprising:
a transparent opening to permit viewing of a portion of the edge of the mobile computing device that would otherwise be obscured by the cylindrical housing.
